(19) United States
(12) Patent Application Publication
(10) Pub. No.: US 2018/0056707 A1
(43) Pub. Date: Mar. 1, 2018

(54) EPAD SYSTEM AND METHOD

(71) Applicant: MARK EVANS, GRAHAM, NC (US)

(72) Inventor: MARK EVANS, GRAHAM, NC (US)

(21) Appl. No.: 15/248,551

(22) Filed: Aug. 26, 2016

(51) Int. Cl. B43L 15/00; B43L 1/00; B43L 23/08; B43L 13/00

(52) U.S. Cl. CPC B43L 15/00; B43L 13/005; B43L 23/08; B43L 1/00

(57) ABSTRACT

A wearable writing surface system having a wearable writing surface assembly including a writing surface having, a front-surface, a back-surface, a first attachment loop, and a second attachment loop, and a band. As designed, the band wraps about the wrist of the user-wearer such that, as configured, the user-wearer is able to write on the front-surface of the writing surface for on-the-job convenient use, the back-surface adjacent and contacting the wrist of the user-wearer.

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of writing surfaces and more specifically relates to an epad system, a wearable writing surface system.

### 2. Description of Related Art

Construction is the process of constructing a building or infrastructure. Construction differs from manufacturing in that manufacturing typically involves mass production of similar items without a designated purchaser, while construction typically takes place on location for a known client. Construction as an industry comprises six to nine percent of the gross domestic product of developed countries. On a large scale construction starts with planning, design, and financing; and continues until the project is built and ready for use. Smaller construction projects may include commercial and residential renovations and the like. Often during such projects it would be ideal to have something to write notes and measurements on. A suitable solution is desired.

Several attempts have been made to solve the above-mentioned problems such as those found in U.S. Pub. Nos. 2003/0011190; 2011/0086335, and U.S. Pat. No. 5,237,651. This art is representative of wearable writing surfaces. However, none of the above inventions and patents, taken either singly or in combination, is seen to describe the invention as claimed.

### BRIEF SUMMARY OF THE INVENTION

In view of the foregoing disadvantages inherent in the known wearable writing surfaces art, the present invention provides a novel wearable writing surface system, entitled ‘epad’. The general purpose of the present invention, which will be described subsequently in greater detail is to provide a writing surface that may be worn on a wrist of a user-wearer.

A wearable writing surface system is disclosed herein, in a preferred embodiment, comprising a wearable writing surface assembly including a writing surface having, a front-surface, a back-surface, a first attachment loop, and a second attachment loop, and a band; wherein the wearable writing surface assembly comprises in functional combination the writing surface and the band.

Referring now to the band, the band is connectable to the writing surface via the first attachment loop, and the second attachment loop; wherein the band is flexible being elastically deformable and adjustable. In preferred embodiments the band comprises hook and loop fasteners (other suitably equivalent fastening means may be used). The band comprises a pencil sharpener; wherein the pencil sharpener is preferably sewn-attached (or otherwise attached) to the band.

The writing surface is defined by the front-surface and the back-surface separated by a thickness yet integral to each other; wherein the writing surface is rigid. The writing surface may comprise acrylic slate, plastic or other suitable material suitable for writing on. The writing surface is planar; wherein the front-surface comprises a writable-surface such that when a glass pencil is used for writing written indicia is retained and the writable-surface being erasable.

The first attachment loop and the second attachment loop preferably comprise metal and may be inset into thickness of the writing surface. The first attachment loop and the second attachment loop are affixed to (or into) the thickness; the first attachment loop and the second attachment loop located opposed to each other such that the writing surface is able to be stably positioned in relation to a wrist of a user-wearer. As designed, the band wraps about the wrist of the user-wearer such that, as configured, the user-wearer is able to write on the front-surface of the writing surface for on-the-job convenient use, the back-surface adjacent and contacting the wrist of the user-wearer.

A kit is also disclosed herein including: the wearable writing surface assembly including the pencil sharpener, and the glass pencil.

The present invention holds significant improvements and serves as a wearable writing surface system. Preferably, a wearable writing surface should provide a writing surface that may be worn on a wrist of a user-wearer and, yet would operate reliably and be manufactured at a modest expense. Thus, a need exists for a reliable wearable writing surface system to avoid the above-mentioned problems.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present disclosure, wearable writing surface system, constructed and operative according to the teachings of the present disclosure.

FIG. 1 shows a perspective view illustrating a wearable writing surface system during an ‘in-use’ condition according to an embodiment of the disclosure.

FIG. 2 is a perspective view illustrating the wearable writing surface system comprising a wearable writing surface assembly according to an embodiment of the present invention of the disclosure.

FIG. 3 is a perspective view illustrating the wearable writing surface assembly according to an embodiment of the present disclosure.

FIG. 4 is a perspective view illustrating the wearable writing surface assembly according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a wearable writing surface means and more particularly to a wearable writing surface system as used to improve the efficiency of writing during work projects.

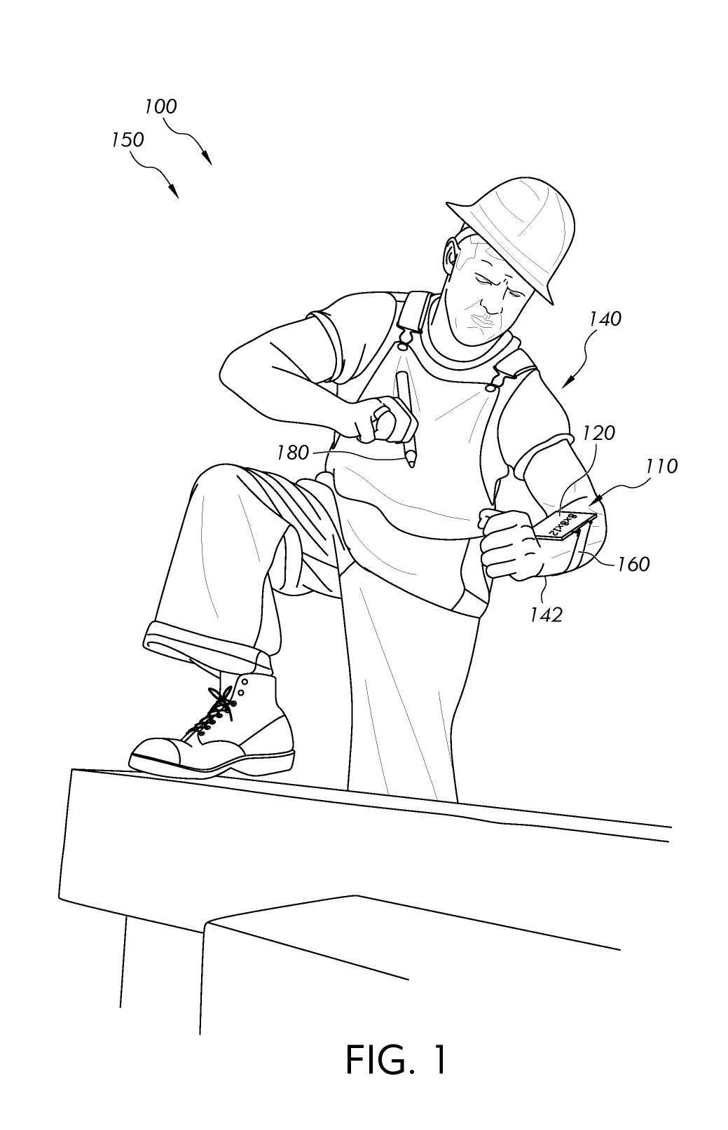

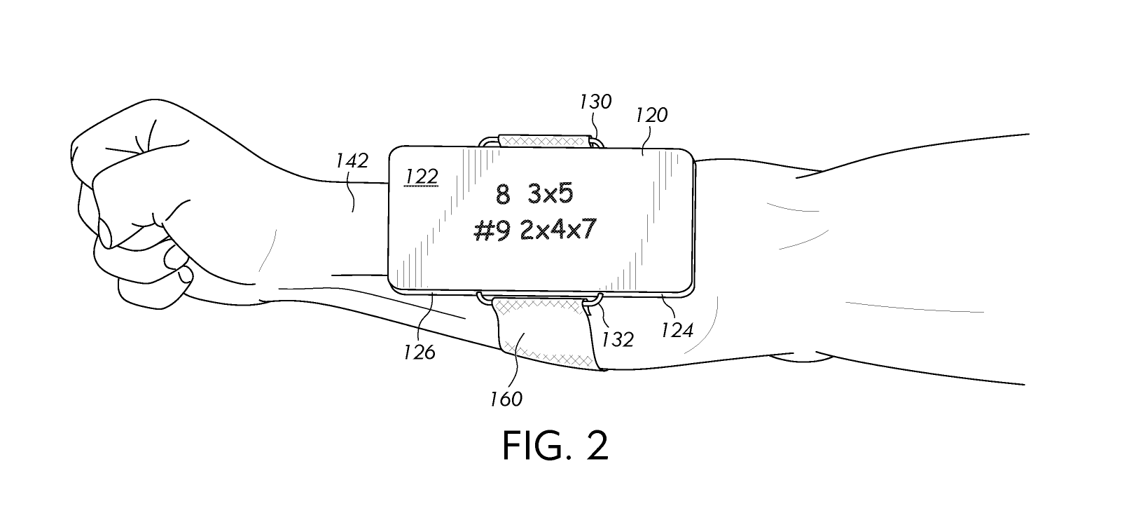

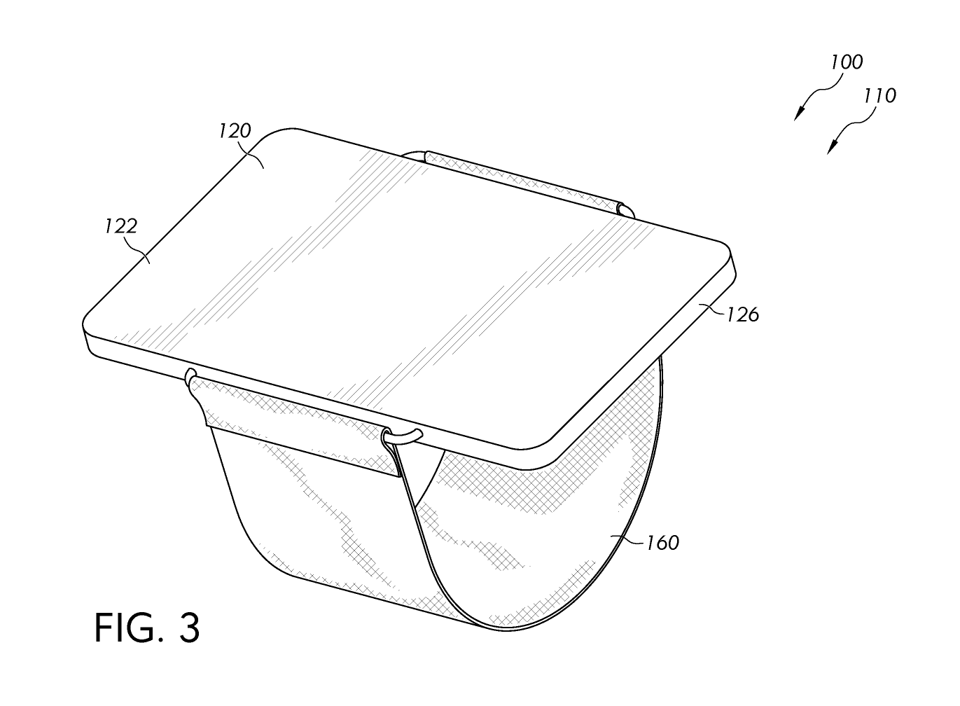

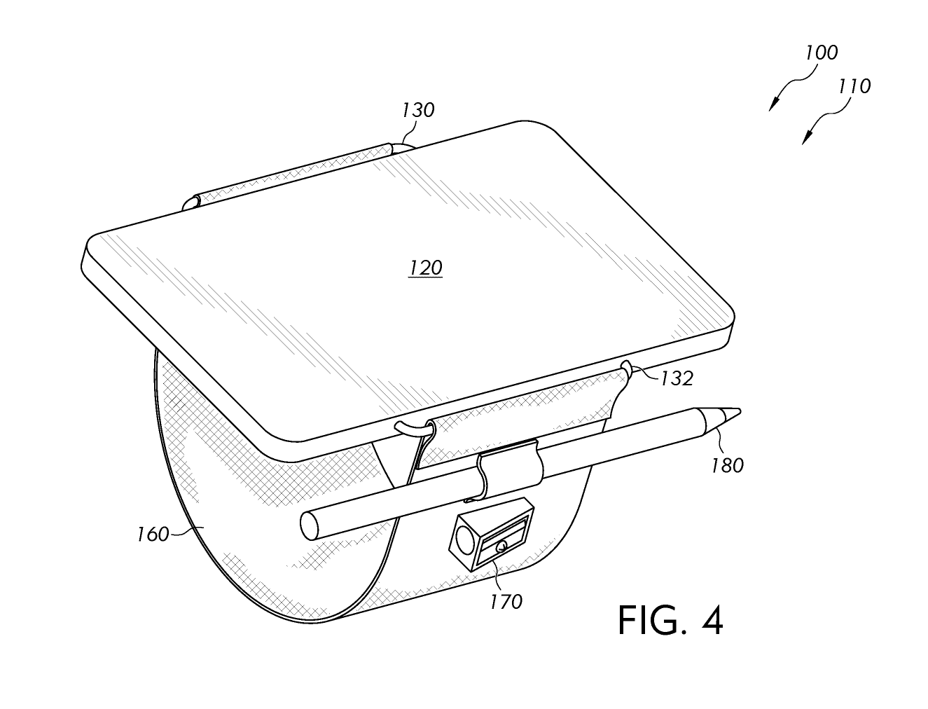

Referring now more specifically to the drawings by numerals of reference there is shown in FIGS. 1-4, various views of wearable writing surface system 100 comprising wearable writing surface assembly 110 including writing surface 120 having front-surface 122, back-surface 124, first attachment loop 130, and second attachment loop 132, and band 160; wherein wearable writing surface assembly 110 of wearable writing surface system 100 comprises in functional combination writing surface 120 and band 160 shown in ‘in-use’ condition 150 in FIG. 1.

Band 160 is connectable to writing surface 120 via first attachment loop 130, and second attachment loop 132. Writing surface 120 is defined by front-surface 122 and back-surface 124 separated by thickness 126. First attachment loop 130 and second attachment loop 132 are affixed to thickness 126; first attachment loop 130 and second attachment loop 132 located opposed to each other such that writing surface 120 is able to be stably positioned in relation to wrist 142 of user-wearer 140. Band 160 wraps about wrist 142 of user-wearer 140 such that, as configured, user-wearer 140 is able to write on front-surface 122 of writing surface 120 for on-the-job convenient use; relationally speaking back-surface 124 being adjacent and contacting wrist 142 of user-wearer 140. Band 160 is flexible and elastically deformable.

Writing surface 120 of wearable writing surface assembly 110 is rigid; wherein writing surface 120 may be plastic, or preferably acrylic slate or other suitable material that is suitable durable and able to be written on; wherein writing surface 120 is planar. First attachment loop 130 and second attachment loop 132 may comprise metal.

Band 160 is adjustable via suitable adjustable means such as for example hook and loop fastening means as those used under the tradename VELCRO. Band 160 comprises pencil sharpener 170 in certain embodiments; pencil sharpener 170 may be sewn-attached to band 160. Front-surface 122 comprises writable-surface 120 such that when a glass pencil 180 is used for writing written indicia is retained; wherein writing surface 120 is erasable.

Wearable writing surface system 100 may be sold as a kit comprising the following parts: at least one wearable writing surface assembly 110; at least one pencil sharpener 170; at least one glass pencil 180; and at least one set of user instructions. The kit has instructions such that functional relationships are detailed in relation to the structure of the invention (such that the invention can be used, maintained, or the like in a preferred manner).

Wearable writing surface system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different writing surface and wrist coupling means and combinations, parts may be sold separately, etc., may be sufficient. Certain versions may comprise a pencil holder.

A method of use for wearable writing surface system 100 may comprise the steps of: step one, donning wearable writing surface assembly 110 about wrist 142; step two, writing on writing surface 120 using glass pencil 180; step three, referencing the writing, and step four erasing the writing as desired, and step five removing donning wearable writing surface assembly 110 as desired.

It should be noted that the steps described in the method of use can be carried out in many different orders according to user preference. The use of “step of” should not be interpreted as “step for”, in the claims herein and is not intended to invoke the provisions of 35 U.S.C. §112 (f). Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A wearable writing surface system comprising:
a wearable writing surface assembly including,
a writing surface having,
a front-surface,
a back-surface,
a first attachment loop, and
a second attachment loop, and
a band,
wherein said wearable writing surface assembly comprises in functional combination said writing surface and said band,
wherein said band is connectable to said writing surface via said first attachment loop, and said second attachment loop,
wherein said writing surface is defined by said front-surface and said back-surface separated by a thickness,
wherein said first attachment loop and said second attachment loop are affixed to said thickness, said first attachment loop and said second attachment loop located opposed to each other such that said writing surface is able to be stably positioned in relation to a wrist of a user-wearer, and
wherein said band wraps about said wrist of said user-wearer such that, as configured, said user-wearer is able to write on said front-surface of said writing surface for on-the-job convenient use, said back-surface adjacent and contacting said wrist of said user-wearer.

2. The wearable writing surface system of claim 1 wherein said band is flexible.

3. The wearable writing surface system of claim 2 wherein said band is elastically deformable.

4. The wearable writing surface system of claim 3 wherein said writing surface is rigid.

5. The wearable writing surface system of claim 4 wherein said writing surface is plastic.

6. The wearable writing surface system of claim 5 wherein said writing surface comprises acrylic slate.

7. The wearable writing surface system of claim 4 wherein said first attachment loop and said second attachment loop comprise metal.

8. The wearable writing surface system of claim 5 wherein said writing surface is planar.

9. The wearable writing surface system of claim 3 wherein said band is adjustable.

10. The wearable writing surface system of claim 9 wherein said band comprises hook and loop fastening means.

11. The wearable writing surface system of claim 10 wherein said band comprises a pencil sharpener.

12. The wearable writing surface system of claim 11 wherein said pencil sharpener is sewn-attached to said band.

13. The wearable writing surface system of claim 5 wherein said front-surface comprises a writable-surface such that when a glass pencil is used for writing written indicia is retained.

14. The wearable writing surface system of claim 13 wherein said writable-surface is erasable.

15. A wearable writing surface system comprising:
a wearable writing surface assembly including,
a writing surface having,
a front-surface,
a back-surface,
a first attachment loop, and
a second attachment loop, and
a band,
wherein said wearable writing surface assembly comprises in functional combination said writing surface and said band,
wherein said band is connectable to said writing surface via said first attachment loop, and said second attachment loop,
wherein said band is flexible,
wherein said band is elastically deformable,
wherein said band is adjustable,
wherein said band comprises hook and loop fasteners,
wherein said writing surface is defined by said front-surface and said back-surface separated by a thickness,
wherein said band comprises a pencil sharpener,
wherein said pencil sharpener is sewn-attached to said band,
wherein said writing surface is rigid,
wherein said writing surface comprises acrylic slate,
wherein said writing surface is planar,
wherein said front-surface comprises a writable-surface such that when a glass pencil is used for writing written indicia is retained,
wherein said writable-surface is erasable,
wherein said first attachment loop and said second attachment loop comprise metal,
wherein said first attachment loop and said second attachment loop are affixed to said thickness, said first attachment loop and said second attachment loop located opposed to each other such that said writing surface is able to be stably positioned in relation to a wrist of a user-wearer, and
wherein said band wraps about said wrist of said user-wearer such that, as configured, said user-wearer is able to write on said front-surface of said writing surface for on-the-job convenient use, said back-surface adjacent and contacting said wrist of said user-wearer.

16. The wearable writing surface system of claim 15 further comprising a kit including:
said wearable writing surface assembly including said pencil sharpener, and
said glass pencil.
